(19) United States
(12) Patent Application Publication
(10) Pub. No.: US 2003/0080698 A1
(43) Pub. Date: May 1, 2003

(54) Method of reducing deflection errors for flat intelligent tracking (FIT) CRTs

(76) Inventors: Willem Lubertus Ijzerman, Eindhoven (NL); Marcellinus Petrus Carolus Michael Krijn, Eindhoven (NL); Jozef Johannes Maria Hulshof, Eindhoven (NL); Dirk Johan Adriaan Teuling, Eindhoven (NL)

Correspondence Address: U.S. Philips Corporation, 580 White Plains Road, Tarrytown, NY, 10591, US

(21) Appl. No.: 10/279,282

(22) Filed: Oct. 24, 2002

(30) Foreign Application Priority Data
Oct. 29, 2001 (EP) 01204127.3

(51) Int. Cl. G09G 1/04

(52) U.S. Cl. 315/366; 315/370

(57) ABSTRACT

The present invention relates to a method and a picture display device for reducing cathode drive-induced deflection errors in an index type cathode ray tube (CRT), and especially a flat intelligent tracking (FIT) CRT. The method comprises the steps of generating at least one electron beam; driving said beam by modulating a cathode potential; predicting a deflection error for the beam due to the cathode drive; and controlling compensation means in accordance with said prediction for reducing said deflection error.

The present invention relates to a method of reducing cathode drive-induced deflection errors in an index type cathode ray tube (CRT), and especially a flat intelligent tracking (FIT) CRT. It also relates to a corresponding display device.

Cathode ray tubes (CRT) which do not use a shadow mask, referred to as index display devices, have been discussed for a long time. The index display device is provided with index elements with which the position and/or shape of the electron beam or beams can be measured while they are being deflected across the phosphor lines. However, the problems caused during this control have hitherto been of such a nature that, in spite of the intrinsic advantages of the design, index display devices have not been practical alternatives to the conventional designs. However, recently, a maskless cathode ray tube (CRT) has been proposed in which the electron beams are tracked along phosphor lines. Such a maskless tube, referred to hereinafter as Flat Intelligent Tracking tube (FIT), is described in e.g. WO 00/38212.

In such a FIT tube, a tracking mechanism is used to compensate for any mislanding of the beams, wherein the phosphor lines are separated by an arrangement of intertwining electrodes, in the case of galvanic tracking, or an arrangement of index phosphors, in the case of optical tracking. If the beams deviate from the phosphor lines, a non-zero difference signal will be measured at the terminals of this tracking structure. The phase and magnitude of this tracking signal comprises information on how far the beams are above or beneath their intended path. This information can be used in a feedback loop to steer the beams clear from the electrodes, thereby avoiding color errors.

Electron guns that are used in color CRTs conventionally make use of cathode drive, that is, the cathode potential is modulated in order to modulate the beam current. This implies that the acceleration voltage is also modulated slightly, and as a result, the energy with which the electrons traverse the deflection field depends on the beam current. The deflection angle, in turn, depends on the electron energy. Therefore, modulation of the beam current is accompanied by modulation of the landing position of the beam on the screen. In a CRT of the index type, and especially in a FIT tube, this can lead to unacceptable color errors, as opposed to standard CRTs.

In principle, any information about the deviations in beam position caused by the modulation of the cathode potential is contained in the tracking signal measured at the terminals of the tracking structure. However, the bandwidth of this signal is limited by, inter alia, the RC time of the tracking structure in the case of galvanic tracking or by the decay time of the index phosphors in the case of optical tracking. In practice, the bandwidth of the useful information contained in the tracking signal is an order of magnitude less than the video bandwidth. The tracking mechanism is therefore unable to compensate for the beam displacements resulting from the high-frequency components in the video signal.

Thus, the inventors have discovered that cathode drive, especially in combination with the limited bandwidth of the tracking information, leads to unacceptable displacement errors in CRTs of the index type, and especially FIT CRTs. Moderate displacement errors result in a change of luminance because the electron beams land in the black matrix instead of on the intended phosphor line. For larger displacement errors, the electron beams land on the wrong phosphor line, resulting in an erroneous color being illuminated. The errors will be especially noticeable in the end areas in a direction perpendicular to the scanning direction. Accordingly, for CRTs in which the beams are scanned in a horizontal direction, the color errors will be especially noticeable in the lower and upper parts of the screen. The displacement could be as large as the phosphor line spacing of the FIT CRT, i.e. the distance between two adjacent phosphor lines, which in FIT CRTs is about 0.23 mm. In SLIM, super-SLIM and high-definition CRTs, the maximum displacement will even exceed the distance between adjacent phosphor lines.

The document U.S. Pat. No. 5,399,947 is related to another CRT of an index type not using a shadow mask. However, the device in this document suffers from the same cathode drive effect as discussed above, but in this case the effect occurs in the vertical instead of the horizontal direction.

It is therefore an object of the present invention to provide a modulation method that reduces the deflection sensitivity to acceptable levels, and preferably without changing the common grid structure of the current guns.

This object is achieved with a method and a picture display device as defined in the appended claims.

The invention relates to a method of reducing cathode drive-induced deflection errors in an index-type cathode ray tube (CRT), and especially a flat intelligent tracking (FIT) CRT. The method comprises the steps of generating at least one electron beam; and driving said beam by modulating a cathode potential. It further comprises the steps of predicting a deflection error for the beam due to the cathode drive; and controlling compensation means in accordance with said prediction for reducing said deflection error.

According to the inventive method, a conventional cathode drive could be used, and at the same time the influence of the cathode drive on the landing position of the beams could be alleviated. Furthermore, the inventive method could be implemented easily and at a relatively low cost, because only limited modifications of the normal FIT CRT structure are required.

Preferably, several beams are generated, wherein the steps of predicting and controlling are performed independently for each beam. The compensation then becomes very efficient.

The compensation means preferably comprises at least one deflector for deflecting the beams, and most preferably a magnetic multipole.

The prediction of the deflection error is preferably based on at least the cathode potential and the frame current. Furthermore, the compensation means is preferably additionally controlled in accordance with a feedback tracking signal from the index-type CRT.

The invention also relates to a corresponding picture display device comprising an index-type cathode ray tube (CRT), and preferably a FIT CRT, having means for generating at least one electron beam and a display screen, the CRT using modulation of the cathode potential for driving said beam. Furthermore, it comprises a control unit adapted to predict a deflection error for the beam due to the cathode drive and to control compensation means in accordance with said prediction for reducing said deflection error.

The invention will be described in closer detail in the following with reference to embodiments thereof, illustrated in the attached drawings, wherein:

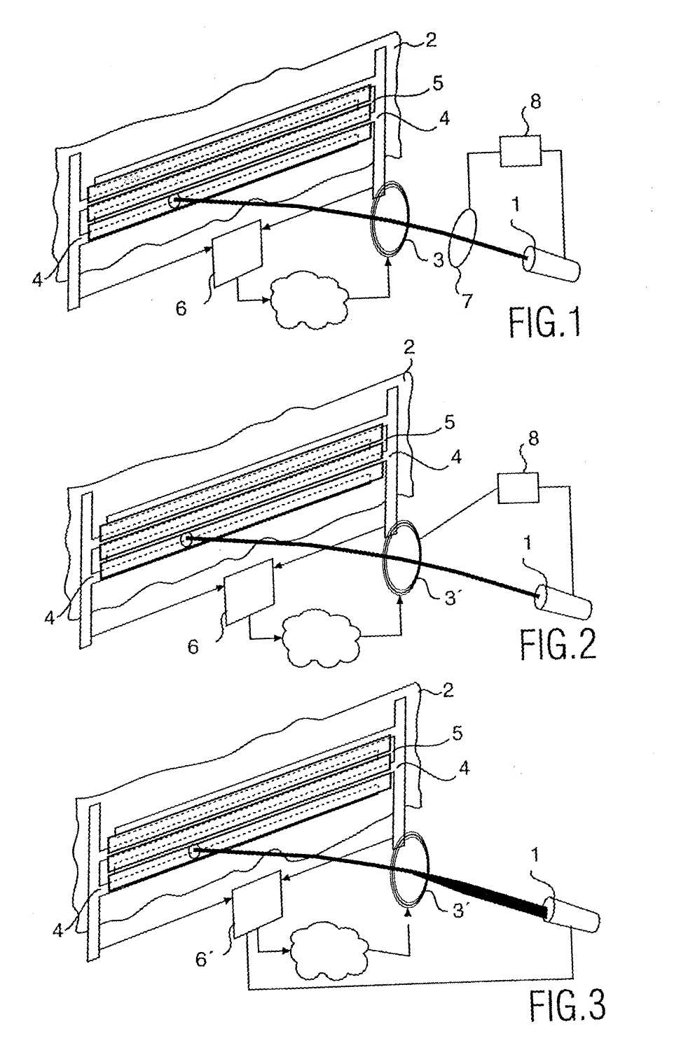

FIG. 1 is a schematic illustration of a FIT picture display device according to a first embodiment of the invention;

FIG. 2 is a schematic illustration of a FIT picture display device according to a second embodiment of the invention;

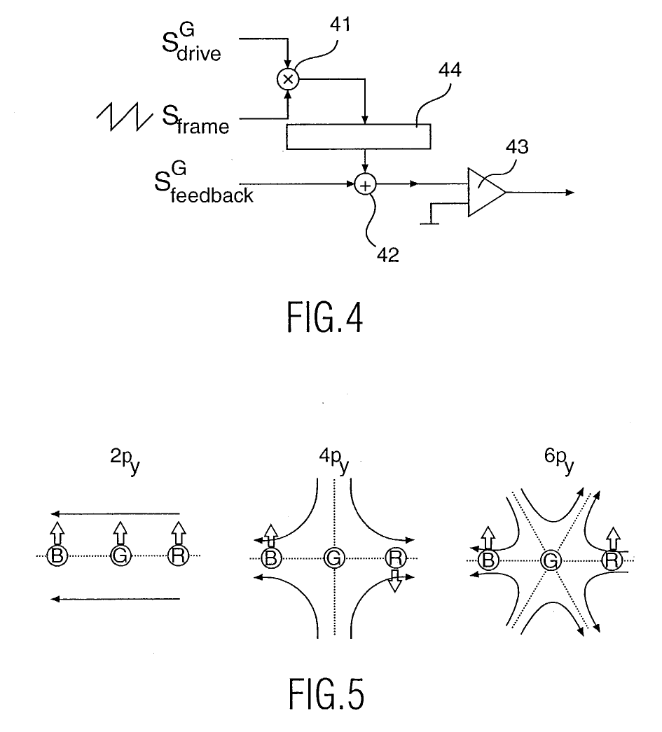

FIG. 3 is a schematic illustration of a FIT picture display device according to a third embodiment of the invention;

FIG. 4 is a schematic illustration of the control circuit for beam control of one beam in a FIT CRT according to the third embodiment of the invention; and

FIG. 5 is a schematic illustration of magnetic multipoles that could be used as a compensation means in the invention.

With reference to FIGS. 1 to 3, the invention generally relates to a picture display device comprising a flat intelligent tracking (FIT) cathode ray tube (CRT) having a gun 1 for generating one or more electron beams, a display screen 2 and a deflector 3 for deflecting the electron beams across the display screen. The deflector preferably comprises a magnetic correction coil, but means for generating or modifying electric fields could be used as well. The display screen preferably comprises a plurality of phosphor elements to form different colors, and preferably red, green and blue. Each color group of phosphor elements forms a pattern on the screen, such as a plurality of parallel lines. The display device is further provided with a tracking mechanism used to compensate for any mislanding of the beams. The tracking mechanism preferably comprises an arrangement of intertwining electrodes 4 separating the phosphor lines 5 on the screen. However, tracking by optical means is also a possibility. Both the phosphor lines and the electrodes are preferably arranged horizontally on the screen, but other directions, such as a vertical arrangement, are possible as well. The electrodes are connected to a feedback position controller 6, which in turn is connected to the deflector 3 for controlling the deflection imposed on the beam. Such a picture display device is generally disclosed in WO 00/38212, said document hereby being incorporated by reference.

If the beams deviate from an intended position on the phosphor lines, a non-zero difference signal will be measured by the electrodes of the tracking structure. The phase and magnitude of the tracking signals thereby generated comprise information on how far the beams are above or beneath their intended path. Based on this information, the position controller generates a feedback signal to the deflector in order to correct the beam deflection accordingly, and to steer the beams to the center of the phosphor tracks. In this case, the CRT does not require the use of a conventional shadow mask, which is advantageous (see the discussion above).

In electron guns that make use of cathode drive, modulation of the cathode potential leads to a beam displacement on the screen, and this problem is especially apparent in FIT tubes. Furthermore, the displacement on the screen in the direction opposite to the scanning direction poses a significantly greater problem than in the scanning direction. Accordingly, since the scanning is normally performed in the horizontal direction, the displacement in the vertical direction is the most significant problem. It has been concluded by the inventor that the beam displacements on the screen in the direction perpendicular to the scanning direction, i.e. the vertical direction, are linear in a good approximation. The magnitude of the displacement is given by:

$$\frac{Δ Y}{Y} = - \frac{1}{2} \frac{{I}_{f r a m e}}{Y} \frac{\partial Y}{\partial {I}_{f r a m e}} \frac{Δ {V}_{c a t h}}{{V}_{a n o d e}} \qquad ( 1 )$$

Here, ΔY is the vertical displacement at vertical screen position Y, resulting from a variation of the cathode potential by an amount ΔV_{cath}. In practice, the relation between vertical beam position Y and frame coil current I_{frame} is approximately linear, in which case (1) simplifies to:

$$\frac{Δ Y}{Y} \approx - \frac{1}{2} \frac{Δ {V}_{c a t h}}{{V}_{a n o d e}} \qquad ( 2 )$$

To summarize, the beam displacement is linear in the change of cathode potential as well as linear in the vertical beam position. In other words, the beam displacements are essentially linear functions of the frame-coil current and the cathode potential. Since the proportionality constants are known or can be measured, it is possible to predict the beam displacements in advance.

The solution offered by the invention is to calculate the beam displacement to be expected and to apply a counteracting and compensating signal to a (dedicated) compensation means, such as a vertical beam deflector.

To this end, the picture display device as described above with reference to FIG. 1 further comprises a feed-forward control unit 8 and compensation means 7. The compensation means 7 is preferably a vertical deflector. The control unit may be either software or hardware-based, and receives signals from the beam generation means 1, and provides an output signal for feed-forward control of the compensation means. The feed-forward control unit 8 receives a signal which is proportional to the cathode voltage or cathode drive potential V_{cat}, such as the cathode signal S_{cath} or the cathode drive signal S_{drive}, and a signal which is proportional to the frame current, such as the frame signal S_{frame} and generates a feed-forward control signal to be fed to the compensation means 7 for compensation of cathode drive-induced displacement of the beam.

The same compensation means 3′ may be used for the feedback compensation provided by the feedback control unit 6 and the feed-forward control unit 8. This embodiment is schematically illustrated in FIG. 2.

The control units for feed-forward and feedback compensation may be integrated in the same control unit 6′, as is schematically illustrated in FIG. 3.

In the embodiments discussed above, one beam is used for scanning the display screen. However, it is also possible to use several beams, such as one beam for each of the colors Red (R), Green (G) and Blue (B). In that case, compensation for each beam is preferably performed independently, and separate control systems could be provided for each beam.

A preferred embodiment of the principle of a control unit for use in the third embodiment is schematically illustrated in FIG. 4. In this control circuit, a signal which is proportional to the cathode voltage or cathode drive potential V_{cat}, such as the cathode signal S_{cath} or the cathode drive signal S_{drive}, is multiplied in a multiplier 41 by a signal which is proportional to the frame current, such as the frame signal S_{frame}. The signal resulting after the multiplication is then added in an adder 42 to the feedback signal deduced from the tracking signal that is measured at the terminals of the tracking structure 4. If necessary, the combined signal is amplified in an amplifier 43, and then fed to the compensation means 3′, such as a deflector, that is able to correct the position of the intended beam. Optionally, a high-pass filter could be arranged to reduce the interaction between the low-frequency errors that are corrected by the feedback system and the high-frequency errors due to the cathode drive.

An analog implementation according to this embodiment leads to a limited additional cost, essentially the cost of 3 multipliers, 3 adders, and the cost of upgrading the amplifiers to a bandwidth of typically 5 MHz for TVT applications.

Similar control unit architectures could be used for the other embodiments discussed above, and for other beams when several beams are used.

The compensation means could be a deflector comprising a combination of a magnetic field positioned around the neck of the CRT. Since the correction signals are small, these multipoles need only few windings. Such a deflector is one option to deflect each beam individually by small amounts perpendicular to the phosphor lines. Such a multipole could include a dipole (2py), a quadrupole (4py), and a sextupole (6py). Their fields and the resulting effect on each of the three beams are depicted in FIG. 5. By taking the proper linear combination of the depicted fields, one is able to deflect each beam individually. To move the blue beam, the excitation current should be proportional to 4py+6py. For the green beam, it should be proportional to 2py−6py, and for the red beam, proportional to 4py−6py.

Accordingly, by addressing these multipoles in the proper linear combination, it is possible to deflect each beam individually. The construction of the multipoles should be such that it allows a high bandwidth. In practice, their construction will be similar to that of the additional dipole coil used for scan velocity modulation. However, the deflector may also use electric fields.

Specific embodiments of the invention have been described. However, several alternatives are possible and will be apparent to those skilled in the art. For example, other control circuit solutions may be used, other compensation means are feasible, etc. Such and other obvious modifications should be considered to be within the scope of the present invention as defined in the appended claims.

1. A method of reducing cathode drive-induced deflection errors in an index type cathode ray tube (CRT), comprising the steps of:
generating at least one electron beam; and
driving said beam by modulating a cathode potential, characterized in that it further comprises the steps of:
predicting a deflection error for the beam due to the cathode drive; and
controlling compensation means in accordance with said prediction for reducing said deflection error.

2. The method of claim 1, wherein the index type CRT is a flat intelligent tracking (FIT) CRT.

3. The method of claim 1 or 2, wherein several beams are generated and wherein the steps of predicting and controlling are performed independently for each beam.

4. The method of any one of the preceding claims, wherein the compensation means comprises at least one deflector for deflecting the beams.

5. The method according to any one of the preceding claims, wherein the prediction of the deflection error is based on at least the cathode potential and the frame current.

6. The method according to any one of the preceding claims, wherein said compensation means is additionally controlled in accordance with a feedback tracking signal from the index type CRT.

7. The method of claim 6, wherein the compensation means is controlled in accordance with a control signal, said control signal comprising a multiplication of a signal which is proportional to the cathode potential and a signal which is proportional to the frame current, and a subsequent addition of a signal which is proportional to the tracking signal for the index type CRT.

8. A picture display device comprising an index type cathode ray tube (CRT) having means (1) for generating at least one electron beam and a display screen (2), the CRT using modulation of the cathode potential for driving said beam, characterized in that it further comprises a control unit (6′;8) adapted to predict a deflection error for the beam due to the cathode drive and to control compensation means (3′;7) in accordance with said prediction for reducing said deflection error.

9. The picture display device of claim 8, wherein the index type CRT is a flat intelligent tracking (FIT) CRT.

10. The picture display device of claim 8 or 9, wherein the compensation means (3′) are also controlled in accordance with a feedback tracking signal from the index type CRT.

11. The picture display device of any one of claims 8 to 10, wherein the control unit is adapted to receive signals which are representative of the cathode potential and the frame current, and to predict the deflection error based on said signals.

12. The picture display device of any one of claims 8 to 11, wherein the deflector comprises a magnetic multipole.
